(19) United States
(12) Patent Application Publication
(10) Pub. No.: US 2016/0210349 A1
(43) Pub. Date: Jul. 21, 2016

(54) GENERATING CONTENT RELATIONSHIPS BASED ON AGGREGATE USER SOLICITED FEEDBACK

(71) Applicant: Knewton, Inc., New York, NY (US)

(72) Inventors: George B. Davis, Brooklyn, NY (US); John O. Davies, New York, NY (US); David L. Kuntz, Richboro, PA (US)

(21) Appl. No.: 15/002,389

(22) Filed: Jan. 20, 2016

Related U.S. Application Data
(60) Provisional application No. 62/105,562, filed on Jan. 20, 2015.

(51) Int. Cl. G06F 17/30

(52) U.S. Cl. CPC G06F 17/30598

(57) ABSTRACT

Systems, methods, and related technologies for generating content relationships based on aggregate user feedback are described. In certain aspects, a plurality of content items can be received, each of the content items being associated with one or more respective metadata items. The plurality of content items and one or more corresponding metadata items can be processed to identify two or more potentially related content items. The two or more potentially related content items can be provided to one or more users. One or more feedback items with respect to the relationship between the two or more potentially related content items can be received from the one or more users. At least one of the two or more potentially related content items can be categorized based on the one or more feedback items.

### CROSS-REFERENCE TO RELATED APPLICATIONS

This application is related to and claims the benefit of U.S. Patent Application No. 62/105,562, filed Jan. 20, 2015 which is incorporated herein by reference in its entirety.

### TECHNICAL FIELD

Aspects and implementations of the present disclosure relate to generating content relationships based on aggregate user feedback.

### BACKGROUND

Traditional learning systems and technologies are often preconfigured based on a group of test users or on a single pre-test evaluation for an individual student. Accordingly, the manner in which such systems are configured may not be optimal for certain users and/or may become suboptimal over time.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

In one aspect of the present disclosure, a processing device can receive a plurality of content items, each of the content items being associated with one or more respective metadata items. The processing device can process the plurality of content items and one or more corresponding metadata items to identify two or more potentially related content items. The processing device can provide the two or more potentially related content items to one or more users. The processing device can receive one or more feedback items with respect to the relationship between the two or more potentially related content items from the one or more users. The processing device can categorize at least one of the two or more potentially related content items based on the one or more feedback items.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an illustrative system architecture, in accordance with one implementation of the present disclosure.

FIG. 2 depicts an exemplary implementation of a device in accordance with aspects and implementations of the present disclosure.

FIG. 3 depicts a flow diagram of aspects of a method for generating content relationships based on aggregate user feedback in accordance with one implementation of the present disclosure.

FIG. 4 depicts a block diagram of an illustrative computer system operating in accordance with aspects and implementations of the present disclosure.

### DETAILED DESCRIPTION

Aspects and implementations of the present disclosure are directed to generating content relationships based on aggregate user feedback.

A structured description of content is an important component of many systems, such as those which interpret or prescribe interactions with content, such as analytic and recommendation systems. Extracting a conceptual ontology efficiently can be an important determinant of which content can be profitably utilized in such a system. Methods, systems and computer program products for generating a conceptual ontology for a given body of content based on aggregate user feedback are disclosed. The body of content may be received from any source, and the body of content may be organized in any manner at the source.

As described herein, in one example, a body of content (e.g. text, such as that contained in a traditional print textbook, and/or instructional videos teaching a middle school mathematics topic) may be analyzed to identify content modules (e.g., a unit, portion, or subset of the content), identify characteristics of such content modules, and to identify learning concepts that are intended to be conveyed through such content modules, based on a standard framework, such as in order to allow the content to be used within a standardized adaptive learning environment framework. Thus, various pieces of content, whether or not designed for adaptivity and regardless of the source or provider of the content, may be analyzed and represented in a consistent way. This allows content of various forms and arrangements to be integrated into a common adaptive learning environment.

The content modules, concepts, and relationships may then be represented and described using one or more data structures, such as a graph having nodes (e.g., content modules and concepts) and edges (e.g., relationships), as a set of associated tags and attributes, or any combination thereof. A graph representing content modules, concepts, and relationships may be referred to as a “course graph.” Each course graph may be created/defined using (and can thus include or otherwise incorporate or reflect) a standard set of entities, relationships, and terminology that allows content from any source to be described in a consistent way so as to allow such content to be incorporated into the same adaptive learning framework.

A course graph may be, for example, a specific definition/identification of concepts, relationships, and/or sequences in relation to a plurality of one or more content items. The course graph may define content modules, which are references to individual content items. For example, a single textual paragraph, a chapter, a video, a quiz, a test, a question, or any other unit or subunit of content may be considered a content module.

A course graph also may define concepts (e.g., learning concepts), which can represent a hypothesis or estimation as to the subject matter and/or skills that are intended to be conveyed to a student by a piece of content. Further, a course graph may define or describe one or more relationships between a plurality of content modules, between a plurality of concepts, and also between content modules and concepts. Several types of course graph relationships may include, but are not limited to, “prerequisite” relationships between concepts, “taught by” relationships between a content module and a concept, “assessed by” relationships from concepts to content modules, and “containment” relationships between different content modules. The relationships in a course graph suffice to enumerate one or more valid learning paths within a body of content and/or across multiple bodies of content. For example, relationships may be used to identify one or more concepts that a student should know before the student consumes another module so that the student is adequately prepared to perform well on the other module.

In one example, a course graph for a body of content is created by a creator or owner of such content. In another example, a course graph is created by someone other than a creator or owner of the content, such as one or more subject matter experts or an expert in the practice of generating ontologies. A course graph may be also be refined or created in whole or in part by crowdsourcing, such as is described herein, by providing/presenting content modules to various users at various stages of the course graph creation process, and soliciting feedback from such users with respect to the presence (or absence) of various relationships between such content modules. For example, a course graph may be first constructed and then refined by an automated process, such as using feedback from a group of various individuals in an online community, such as in the manner described herein. In other examples, the referenced course graph can be generated in an automated fashion, such as based on the feedback received from various users (whether subject matter experts or not), such as in the manner described herein. The various individuals participating in the crowdsourcing may include, but are not limited to, users having a specific skillset, expertise, credential and/or background that have been pre-screened. In some examples, the various individuals may include any user on the Internet.

For example, a course graph may be defined using an automated process, such as algorithmic or machine learning process that identifies concepts that exist or that may exist in the content. The automated process also may identify relationships that exist or that may exist between identified concepts, as well as between identified concepts and the content itself. Additionally, in certain implementations feedback received from various users (e.g., students), such as in response to various questions (which, for example, may request that the user characterize the relationship between two content items) can be utilized in generated the referenced course graph.

Once a course graph has been created for a body of content, the properties and attributes of the graph, which may include relationships among content modules and concepts and the strength of those relationships (e.g. coefficients), may be adjusted continually or periodically over time based on student interactions (e.g., the same student or different students) with the body of content represented by the course graph. Further, the information about the content may be used in conjunction with student interactions and a context describing educational goals for one or more students to generate personalized or customized learning recommendations as an ordered list of content modules.

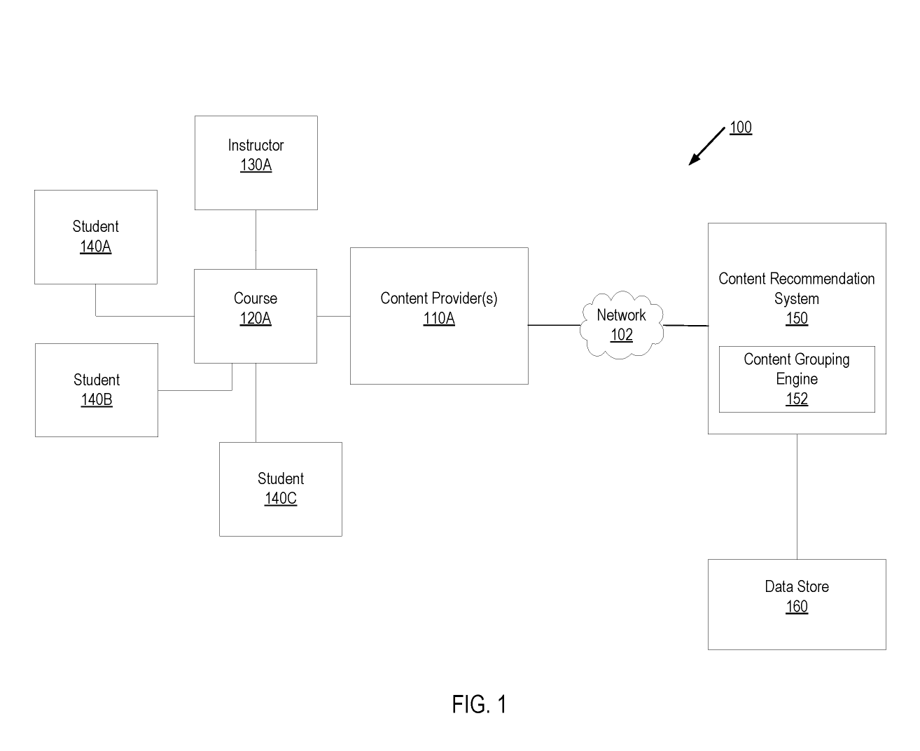

FIG. 1 illustrates a block diagram of a content recommendation system architecture, in accordance with various embodiments of the present disclosure. The content recommendation system architecture 100 includes network 102, content providers 110A, courses 120A, instructors 130A, students 140A-C, content recommendation system 150, and data store 160. Network 102 may be, for example, a public network (e.g., the Internet), a private network (e.g., a local area network (LAN) or wide area network (WAN)), or a combination thereof. The content recommendation system architecture 100 includes one or more computer systems/devices connected to a network 102. Examples of such computer systems/devices include but are not limited to content providers 110A, instructors 130A, students 140A-C, and content recommendation system 150.

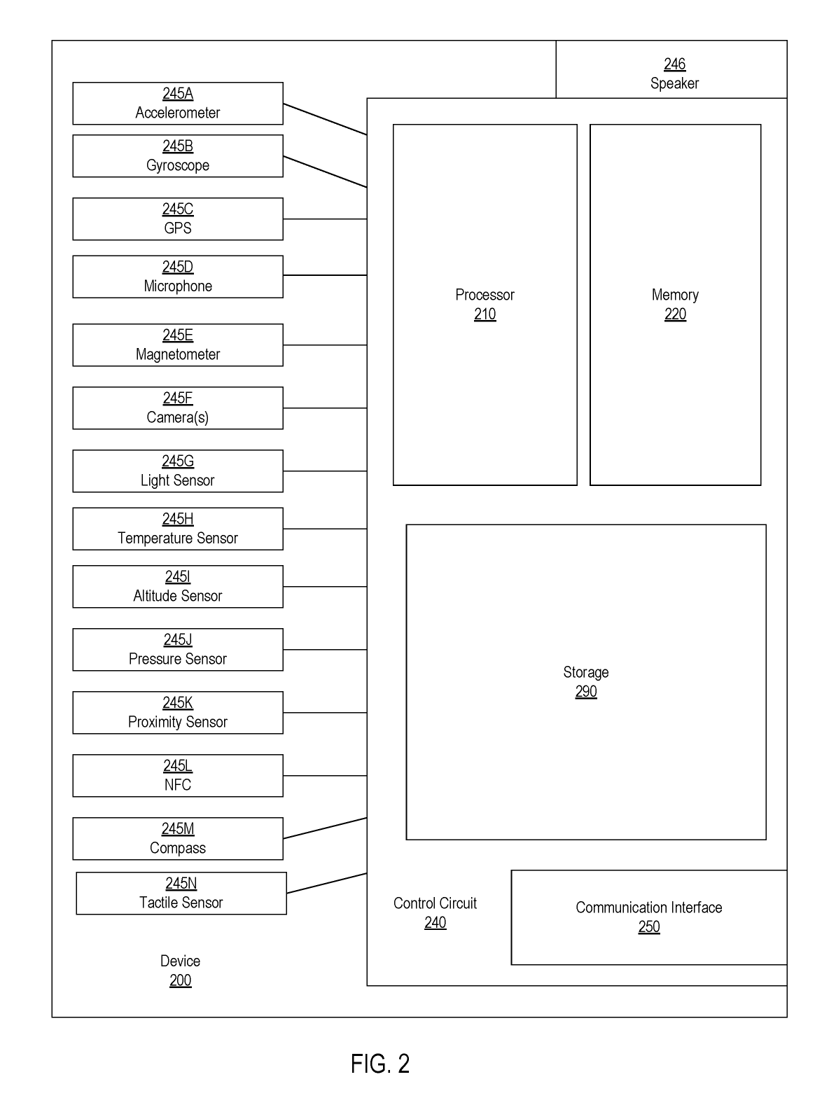

Each of the referenced computer systems/devices can be, for example, a rackmount server, a router computer, a personal computer, a portable digital assistant, a mobile phone, a laptop computer, a tablet computer, a camera, a video camera, a netbook, a desktop computer, a media center, a smartphone, a watch, a smartwatch, an in-vehicle computer/system, a wearable device, any combination of the above, or any other such computing device capable of implementing the various features described herein. Various applications, such as mobile applications (‘apps’), web browsers, etc. may run on the user device (e.g., on the operating system of the user device). It should be understood that, in certain implementations, the referenced computer systems/devices can also include and/or incorporate various sensors and/or communications interfaces (including but not limited to those depicted in FIG. 2 and/or described herein). Examples of such sensors include but are not limited to: accelerometer, gyroscope, compass, GPS, haptic sensors (e.g., touchscreen, buttons, etc.), microphone, camera, etc. Examples of such communication interfaces include but are not limited to cellular (e.g., 3G, 4G, etc.) interface(s), Bluetooth interface, WiFi interface, USB interface, NFC interface, etc.

As noted, in certain implementations, the referenced computer systems/devices can also include and/or incorporate various sensors and/or communications interfaces. By way of illustration, FIG. 2 depicts one exemplary implementation of such a device 200. As shown in FIG. 2, device 200 can include a control circuit 240 (e.g., a motherboard) which is operatively connected/coupled to various hardware and/or software components that serve to enable various operations, such as those described herein. Control circuit 240 can be operatively connected to processor 210 and memory 220. Processor 210 serves to execute instructions for software that can be loaded into memory 220. Processor 210 can be a number of processors, a multi-processor core, or some other type of processor, depending on the particular implementation. Further, processor 210 can be implemented using a number of heterogeneous processor systems in which a main processor is present with secondary processors on a single chip. As another illustrative example, processor 210 can be a symmetric multi-processor system containing multiple processors of the same type.

Memory 220 and/or storage 290 may be accessible by processor 210, thereby enabling processor 210 to receive and execute instructions stored on memory 220 and/or on storage 290. Memory 220 can be, for example, a random access memory (RAM) or any other suitable volatile or non-volatile computer readable storage medium. In addition, memory 220 can be fixed or removable. Storage 290 can take various forms, depending on the particular implementation. For example, storage 290 can contain one or more components or devices. For example, storage 290 can be a hard drive, a flash memory, a rewritable optical disk, a rewritable magnetic tape, or some combination of the above. Storage 290 also can be fixed or removable.

A communication interface 250 is also operatively connected to control circuit 240. Communication interface 250 can be any interface (or multiple interfaces) that enables communication between device 200 and one or more external devices, machines, services, systems, and/or elements (including but not limited to those depicted in FIG. 1 and described herein). Communication interface 250 can include (but is not limited to) a modem, a Network Interface Card (NIC), an integrated network interface, a radio frequency transmitter/receiver (e.g., WiFi, Bluetooth, cellular, NFC), a satellite communication transmitter/receiver, an infrared port, a USB connection, or any other such interfaces for connecting device 200 to other computing devices, systems, services, and/or communication networks such as the Internet. Such connections can include a wired connection or a wireless connection (e.g. 802.11) though it should be understood that communication interface 250 can be practically any interface that enables communication to/from the control circuit 240 and/or the various components described herein.

At various points during the operation of described technologies, device 200 can communicate with one or more other devices, systems, services, servers, etc., such as those depicted in FIG. 1 and/or described herein. Such devices, systems, services, servers, etc., can transmit and/or receive data to/from the user device 200, thereby enhancing the operation of the described technologies, such as is described in detail herein. It should be understood that the referenced devices, systems, services, servers, etc., can be in direct communication with user device 200, indirect communication with user device 200, constant/ongoing communication with user device 200, periodic communication with user device 200, and/or can be communicatively coordinated with user device 200, as described herein.

Also connected to and/or in communication with control circuit 240 of device 200 are one or more sensors 245A-245N (collectively, sensors 245). Sensors 245 can be various components, devices, and/or receivers that can be incorporated/integrated within and/or in communication with user device 200. Sensors 245 can be configured to detect one or more stimuli, phenomena, or any other such inputs, described herein. Examples of such sensors 245 include, but are not limited to, an accelerometer 245A, a gyroscope 245B, a GPS receiver 245C, a microphone 245D, a magnetometer 245E, a camera 245F, a light sensor 245G, a temperature sensor 245H, an altitude sensor 245I, a pressure sensor 245J, a proximity sensor 245K, a near-field communication (NFC) device 245L, a compass 245M, and a tactile sensor 245N. As described herein, device 200 can perceive/receive various inputs from sensors 245 and such inputs can be used to initiate, enable, and/or enhance various operations and/or aspects thereof, such as is described herein.

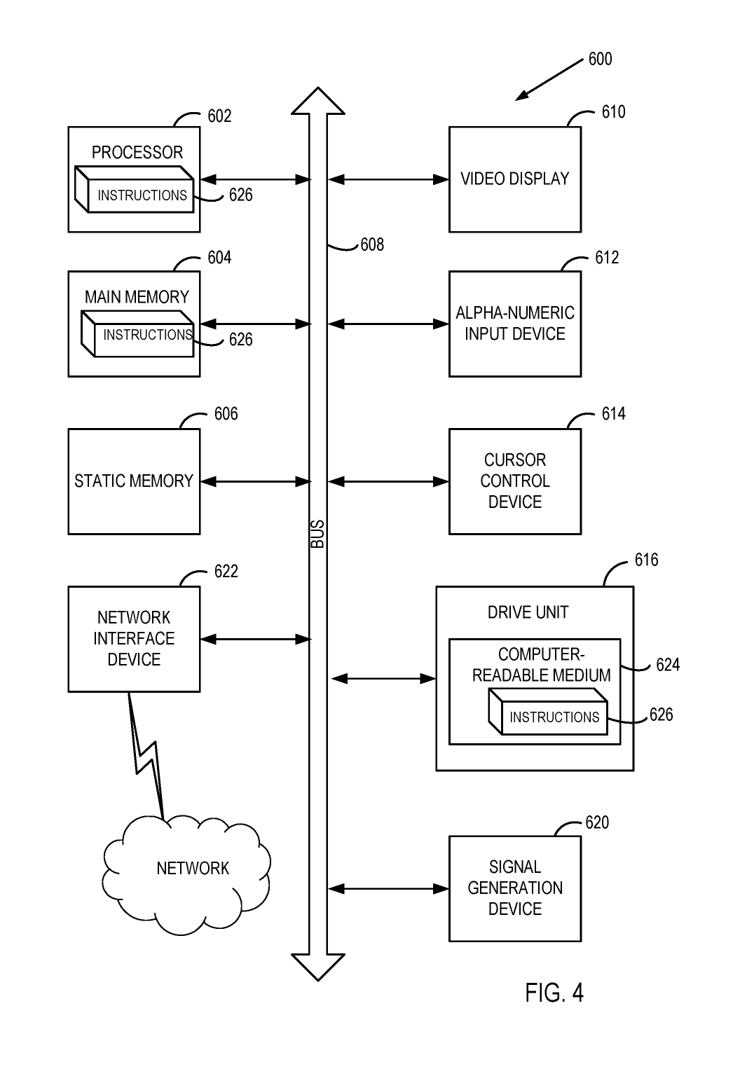

At this juncture it should be noted that while the foregoing description (e.g., with respect to sensors 245) has been directed to user device 200, various other devices, systems, servers, services, etc. (such as are depicted in FIG. 1 and/or described herein) can similarly incorporate the components, elements, and/or capabilities described with respect to device 200. It should also be understood that certain aspects and implementations of various devices, systems, servers, services, etc., such as those depicted in FIG. 1 and/or described herein, are also described in greater detail below in relation to FIG. 4.

A server machine (e.g., content recommendation system 150) may be a virtual machine, a cloud computing resource, rackmount server, a router computer, a personal computer, a portable digital assistant, a mobile phone, a laptop computer, a tablet computer, a computer gaming device, a camera, a video camera, a netbook, a desktop computer, a media center, any combination thereof, or any other such computing device capable of implementing the various features described herein. It should be understood that, in certain implementations, the referenced server can also include and/or incorporate various sensors and/or communications interfaces (including but not limited to those depicted in FIG. 2 and described in relation to user device 200). The components can be combined together or separated in further components, according to a particular implementation. It should be noted that in some implementations, various components of the referenced server may run on separate machines. Moreover, some operations of certain of the components are described in more detail below.

The content recommendation system architecture 100 also may include a persistent data store 160, such as a file server or network storage, capable of storing various types of data. In some embodiments, the data store might include one or more other types of persistent storage such as one or more object-oriented databases, relational databases, graph databases, in-memory databases, and so forth. Additionally, in certain implementations data store 160 may be directly connected and/or remote storage resources which store the objects described/referenced herein. In various implementations, data store 160 can be one or more storage devices, such as main memory, magnetic or optical storage based disks, tapes or hard drives, NAS, SAN, and so forth. In some implementations, data store 160 can be a network-attached file server, while in other implementations data store 160 can be some other type of persistent storage such as an object-oriented database, a relational database, and so forth. It should be understood that while data store 160 is depicted as being independent of content recommendation system 150 (e.g., as a connected or remote device), in certain implementations data store 160 may also be hosted by content recommendation system 150.

Content providers 110A are generally entities that create, manage and/or distribute content. Content providers 110A may manage and distribute their own content or content that has been created by or received from one or more other sources. Content may include, for example, text, audio, video, images, etc. Further, content may be aggregated from multiple sources and then distributed as a combined piece of content. In one example, a content provider 110A may be a publisher of educational content or a technology provider that allows various parties to provide content for their own implementation/another party's implementation of the technology provider's software.

In one example, a content provider 110A publishes a textbook (e.g., electronic or print) that an instructor 130A uses to teach a subject as part of a course 120A, used by students 140A-C. The textbook may be organized into a set of chapters and subchapters that are associated with various related (or unrelated) topics. The textbook may contain a table of contents to help identify information within the chapters. The textbook also may contain an index to help a user (e.g., a student) find a particular piece of content and/or concept within the text. However, such traditional methods of organizing, labeling, and indexing vary across different content and different content providers.

As described herein, in one example, one or more different content items are each individually analyzed based on a standard framework to identify groupings, concepts, and/or relationships, such as in order to allow the content to be used within a standardized adaptive learning environment framework within a content recommendation system 150. The content recommendation system 150 and/or content grouping engine 152 also may determine and provide a custom, personalized list of content modules from within the content for a student based on a set of one or more learning requirements and available learning paths within the content (e.g., as provided by a course graph). It should be understood that such an arrangement is exemplary and that in other implementations more or fewer content modules/applications may be employed in providing the various features, functionalities, and operations described herein.

It should also be understood that the various elements, components, and/or devices referenced herein can be combined together or separated into further components, according to a particular implementation. Additionally, in some implementations, various components (e.g., of content recommendation system 150) may run on separate machines.

In an example, content recommendation system 150 is accessed directly by one or more different computing systems, such as a computing system associated with a content provider 110A. In another example, content recommendation system 150 may be provided as one or more tools, add-ons, or application programming interfaces (APIs).

As described in greater detail herein, while in certain implementations content grouping engine 152 may generate one or more course graphs describing educational content while in other implementations such course graphs may be generated (e.g., manually) and provided to the content grouping engine. In other implementations such as described in greater detail herein, the content grouping engine 152 may generate one or more course graphs describing a body of concepts, relationships, and/or sequences in relation to one or more content items (or a body of content). A course graph also may define concepts (e.g. learning concepts), which can represent a hypothesis or estimation as to the subject matter and/or skills that are intended to be conveyed to a student by a piece of content. In certain implementations, content grouping engine 152 may also generate a personalized (e.g., ordered, ranked, etc.) list of content modules in a body of content based on one or more factors. Content grouping engine 152 may generate the personalized list of content modules for a student based on one or more of relationships between concepts and content modules for a piece of content as represented in a course graph, proficiency of a student in one or more concepts, attributes and/or preferences of a student, attributes and/or properties of one or more pieces of content, student events associated with one or more pieces of content, and/or one or more pieces of contextual criteria associated with the student and/or content. Content grouping engine 152 may calculate a score or determine a rating reflecting an educational value computed for one or more content modules in a piece of content. Content grouping engine 152 also may rank the content modules based on the score (e.g., a numerical value) or rating (e.g., an evaluation, assessment, code, etc.). In one embodiment, content grouping engine 152 also may store the generated recommendation for later reference, archival, and/or analysis.

Content grouping engine 152 provides the generated list of recommended educational content to an interested party. In one example, content grouping engine 152 transmits the generated list of recommended educational content to a content provider that serves the content to users. The content provider may, for example, use the educational content recommendation when determining material to present to the student. The content provider may also provide a student with an option to select material based on the recommendation.

In one example, content recommendation system 150 is part of or is integrated with a continuous adaptive learning system that continues to refine and fine tune properties and attributes of both students and content over time. For example, unlike traditional learning systems, which may be preconfigured based on a group of test users or on a single pre-test evaluation for an individual student, content recommendation system 150 may receive or observe information about interactions of many different students with content, the effect of which may be combined across many users and different pieces of related content. In an example, content recommendation system 150 continuously refines information about the effectiveness of content and the proficiency of students interacting with that content based on results generated from student-content interactions.

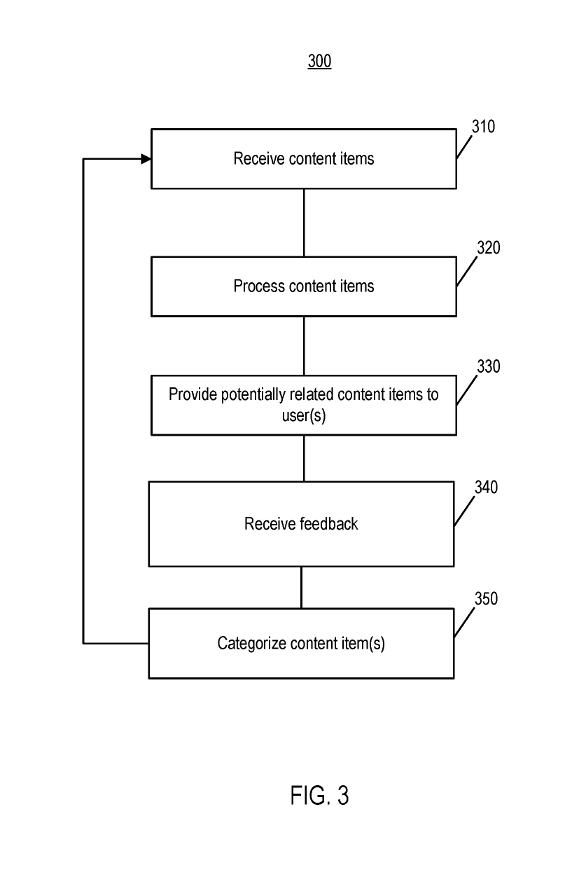

FIG. 3 is a flow diagram illustrating generating content relationships based on aggregate user feedback, according to an embodiment. The method 300 may be performed by processing logic that may comprise hardware (circuitry, dedicated logic, programmable logic, microcode, etc.), software (such as instructions run on a device, computer system, dedicated machine, or processing device, such as are depicted in FIGS. 1, 2, and 4 and described herein), firmware, or a combination thereof. In one implementation, the method 300 is performed using content recommendation system 150 of FIG. 1 while in some other implementations, one or more blocks or stages of method 300 may be performed by one or more other elements, machines, and/or systems.

For simplicity of explanation, methods are depicted and described as a series of acts, operations, and/or stages. However, acts, operations, and/or stages in accordance with this disclosure can occur in various orders and/or concurrently, and with other acts, operations, and/or stages not presented and described herein. Furthermore, not all illustrated acts, operations, and/or stages may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At 310, one or more content items (or a body of content) can be received. In certain implementations the content modules within the body of content can be associated with respective metadata items. For example, a body of educational content (e.g. text, such as from a textbook and/or instructional videos teaching a middle school mathematics topic) can be uploaded/added to the system (such as by a teacher, content publisher, etc.). The referenced metadata can include elements which may be applied to individual and/or groups of content modules, such as Common Core State Standards (e.g., indicating which standards are taught by or assessed by a particular module), descriptions or names of content modules, string tags identifying ‘learning objectives,’ string tags labeling prerequisite ideas, media-type tags (indicating that a piece of content is a video, text, multiple-choice question, etc.), etc. In one aspect, operation 310 is performed by one or more components depicted in FIGS. 1, 2 and/or 4. It should be understood that, in certain implementations, such metadata (or incomplete/insufficient metadata) may not exist when it is received at 310 and may be generated/associated with the respective content modules within the body of content by the content grouping engine 152 using an automated process, such as algorithmic or machine learning process, that identifies relationships that exist or that may exist between content modules within the body of content and groups these content modules based on these identified relationships. The automated process can also be used to create descriptive labels for these module groupings (e.g. by analyzing/parsing the text or other content contained within a content module grouping in order to identify the subject matter, topic phrases, etc. as descriptive labels) and then associated with the respective content modules as metadata.

Additionally, as described herein, in certain implementations various solicitation/evaluation operations can be performed, such as in order to solicit feedback from various users (e.g., subject matter experts or students), such as in response to various questions (which, for example, may prompt the user to characterize the relationship among the identified module groupings or in another example, may request that the users provide descriptive labels that can be applied as metadata to the identified module groupings), that can then be utilized in further characterizing, verifying, refining or rebutting such manual or automated characterizations of the content modules. For clarity, this operation may be optional depending, for example, on metadata provided at 310, such as when the body of content is first received.

At this juncture it should be noted that, in certain implementations, it may be advantageous to consolidate various metadata tags/labels (e.g., descriptive tags that, though technically distinct, are considerably similar to other tags or which are not commonly used), as doing so is likely to increase the number of relationships identified between content modules. For example, in certain implementations the initially applied descriptive metadata labels/tags can be compared with the text of the items themselves and/or with labels/tags used by a standard setting body (e.g. Common Core State Standards). In doing so, a reduced set of descriptive labels can be generated (e.g., labels that are applied by very few users or do not reflect Common Core State Standard labels may be modified or removed).

At 320, the content modules within the body of content can be processed (e.g., by content grouping engine 152), such as using one or more machine learning techniques, using the one or more corresponding metadata items associated with each content module. In doing so, various potentially related content modules can be identified. For example, in certain implementations the associated metadata and/or the received content modules (e.g., the text and/or media of the content) can be algorithmically analyzed/searched to identify content modules and/or groups of content modules that may be likely to assess the same learning concept or have a conceptual relationship (e.g. a first module teaches a concept that is a prerequisite for a concept taught by a second module). By way of illustration, the semantic structure of the metadata and/or the content module itself can be examined/analyzed, and those content modules and/or groups of content modules that are likely to have conceptual relationships can be identified/predicted (e.g., probabilistically), such as by using various machine-learning techniques. In one aspect, operation 320 is performed by one or more components depicted in FIGS. 1, 2 and/or 4. In certain implementations, the referenced processing can be repeated/iterated across multiple content modules included in a body of content. For example, one can be compared to some and/or all of the other content modules included in the body of content. In doing so, one or more content modules that are related to one another can be identified and grouped.

For example, a first set of content modules (‘Set A’) can be identified as sharing a conceptual relationship, each of which can be tagged with “Solving Linear Equations with One Variable” and “Word Problems” (e.g., includes or is associated with corresponding metadata tags). It can be appreciated that various other content modules having such tags in common may be likely to be related to the same concept. A second set of content modules (‘Set B’) can also be identified as being related to one another, such as content modules that are tagged with “Solving Linear Systems with Two Variables” as well as identify such content modules as being likely to depend (e.g., sequentially) on the content modules contained in the first set.

At 330, the two or more potentially-related content modules (such as two content modules within a group identified at 320) can be further validated (e.g. determine with some level of certainty that the content modules are indeed related to the same learning concept), such as by providing such content modules to various users (e.g., subject matter experts, students, etc.) to confirm the potential conceptual relationship. It should be understood that such users may not be experts in the field(s) with respect to which the provided content is associated. In one aspect, operation 330 is performed by one or more components depicted in FIGS. 1, 2, and/or 4.

For example, users of the system (e.g., students), who have disparate knowledge of the relevant topics (middle-school mathematics, in this case), can be provided with comparisons of two (or more) content modules from Set A, and can be prompted to provide feedback as to whether or not the presented content modules assess the same concepts (e.g., “Does Item 1 assess the same learning concept as Item 2?”). In certain implementations, the described operations (e.g., providing/presenting content modules in conjunction with one another, such as in order to prompt users to provide indications regarding their relationship) can be repeated/iterated across multiple content modules within the identified set of content modules. For example, one content module can be compared to some and/or all of the other content modules included in the body of content. In doing so, content modules that are not actually related to one another (and thus do not belong in the same set) can be removed. Additionally, trends/clustering of certain content modules within the set can be identified/determined (e.g. certain relationships can be identified between two content modules based on respective comparisons of each of the content modules against other content module(s)). Additionally, various thresholds can be defined with respect to the presentation of such comparisons. For example, a minimum threshold can be defined, reflecting the minimum number of users such comparisons are to be presented to. By way of further illustration, a threshold can be defined whereby a particular comparison is to be presented to at least a defined number of users (e.g., 100 users) and such comparison is to continue to be presented to additional users until at least a definite portion of the users (e.g., 75%) agree on the same response. Moreover, in certain implementations various further operations can be initiated in scenarios in which such thresholds are not met (e.g., after a certain amount of time, number of presentations, etc.), such as by providing the comparison to a subject matter expert for review, etc.

In certain implementations, in addition to and/or instead of receiving the described feedback via presenting comparisons of content modules and prompting multiple users for feedback, an entire set or a large subset of content modules that have been grouped as being potentially related (e.g., 10-12 items) can be presented to one or more subject matter experts. For example, such content modules can be presented via a graphical user interface, and such experts can utilize the interface to identify various relationships between the various content modules (reflecting, for example, whether they assess the same concept, whether one content module is a prerequisite for another, etc.).

At 340, one or more feedback items can be received, such as from one or more users (e.g., those solicited at 330). In certain implementations, such feedback items can reflect or correspond to the relationship (or lack thereof) between the potentially related content modules (such as those provided at 330). In one aspect, operation 340 is performed by one or more components depicted in FIGS. 1, 2, and/or 4.

For example, in many instances, users may reply ‘yes’ to the inquiry provided at 330. In other instances, certain comparisons may receive “No” answers from many respondents (though it should be noted that such feedback is not necessarily binary, and, in certain implementations the user may also be able to provide a ‘maybe’ response, a ranking/rating, a custom response, etc.). Such content modules (e.g., questions, problems, etc.) can be identified and separated from those other content modules that have been determined (e.g., based on the responses provided by some/many users) to be similar/related to one another, such as with respect to the concept that is intended to be conveyed by such content modules. For example, many users may indicate that the question “Mark has three more apples than 4 times as many as Jake. If Mark has 18 apples, how many does Jake have?” does not assess/teach the same concept as a set of questions such as “When you are solving a linear equation, what is the first step?”

At this juncture it should be noted that, based on the responses provided to the referenced requests for feedback, certain users may be identified as providing feedback which is often inaccurate (whether in general or with respect to a particular subject, topic, question type, etc.). Such users can be identified, for example, based on a determination that a particular user often/always provides responses which are contrary to those provided by many/most other users; the feedback provided by such an identified user can be weighted in a manner that discounts the value of such feedback (or which ignores it entirely). Moreover, users that often provide valuable/accurate feedback can also be identified, and their feedback can be weighted in a manner that increases/emphasizes the value of such feedback.

Based on the feedback received from the referenced users (e.g., with respect to ‘Set A’) and/or the type of questions posed, the various content modules within a set of potentially related content modules can be further clustered, such as by dividing the set into groups belonging to two separate smaller concepts, for example which could be labeled as “Solving linear equations” (e.g., the group of content modules with respect to which many/most users identified a relationship) and “Knowing how to solve linear equations” (e.g., the group of content modules with respect to which a relationship was not identified by many/most users). At this juncture it should be noted that a content module can assess/teach ideas that can be associated with more than one concept and/or more than one label and can therefore be part of more than one set of content modules that is generated from the processing of the content modules using the one or more corresponding metadata items associated with each content module. Additionally, it should therefore be understood that while in certain implementations, one content module may be identified/determined not to be similar/related to another content module as interpreted by a certain set of labels (e.g., one content item/module may pertain to math while another pertains to history), such content modules may still be related to one another with respect to other labels (e.g., both may rely on a set of examples that are part of fourth grade curriculum). Accordingly, in certain implementations, even upon identifying various content modules as being unrelated to one another with respect to one set of labels, further prompts can still be provided comparing such content modules with respect to other sets of labels.

In certain implementations, after the operations described herein (e.g., 310-340) have been iterated across a body of content to solicit feedback from users to first validate the groupings of content modules around being similar/related to the same learning concept, one or more of the operations described herein (e.g., 310-340) can then next be iterated to identify conceptual relationship by presenting various users with comparisons of pairs of content modules (e.g., from different concepts groups), such as one from Set A, and one from Set B. In certain implementations, the metadata tags/labels associated with the content modules within content groupings at 310 can be used to present pairs of content modules that are more likely to have a conceptual relationship (e.g. the first module teaches a concept that is a prerequisite for a concept taught by the second module). Such users can be prompted to provide feedback regarding whether a student would (or would not) need to see/learn/have mastered the content module from set A before the content module from Set B. For example, in many scenarios, users may reply ‘yes’, ‘no’ or ‘maybe’ to such an inquiry (such as when they are shown pairs containing one of the content modules from the “Solving linear equations” concept in Set A). Based on such feedback, certain concepts can be identified as having a stronger, weaker or no relationship (e.g. assigned a coefficient to represent the strength of the relationship) to other concepts. For example a concept identified as being taught by content modules from Set A—“Solving linear equations with word problems”—can be identified as a useful preparation for the concept identified as being taught by the content module from Set B—“Solving Linear Systems with Two Variables”—and the additional concept identified as being taught by content modules from Set A—“Knowing how to solve linear equations with word problems”—can be identified/determined to be necessary/mandatory before attempting to learn the concept identified as being taught by the content module from Set B—“Solving Linear Systems with Two Variables”. In certain implementations, the described operations (e.g., providing/presenting content modules in conjunction with one another, such as in order to prompt users to provide indications regarding their prerequisite relationship) can be repeated/iterated across multiple content modules included in a body of content. For example, one content module can be compared to some and/or all of the other content modules included in the body of content. Additionally, various thresholds can be defined with respect to the presentation of such comparisons. For example, a minimum threshold can be defined, reflecting the minimum number of users such comparisons are to be presented to. By way of further illustration, a threshold can be defined whereby a particular comparison is to be presented to at least a defined number of users (e.g., 100 users) and such comparison is to continue to be presented to additional users until at least a definite portion of the users (e.g., 75%) agree on the same response. Moreover, in certain implementations various further operations can be initiated in scenarios in which such thresholds are not met (e.g., after a certain amount of time, number of presentations, etc.), such as by providing the comparison to a subject matter expert for review, etc.

At this juncture it should be noted that different relationships may be identified for users having different types of characteristics. For example, students sharing one set of characteristics (e.g., relatively stronger students, students having additional background in other areas) may not identify one set of content modules as a prerequisite for another, while students sharing another set of characteristics (e.g., relatively weaker students, students having little or no background in certain other areas) may identify one set of content modules as a prerequisite for another. Accordingly, the feedback provided by different users can be weighted in a manner that accounts for the relative value of such feedback, as described herein.

The described process (and/or portions/sections thereof) can be iterated across some/all content modules and/or identified sets of potentially related content module groupings within the body of content (e.g., in a database). As the process is iterated, additional and/or different users can provide the referenced feedback. In doing so, related content modules, concepts taught/assessed and prerequisites that describe all of the content modules in the group/body of content can be identified.

At 350, one or more of the potentially related content modules and/or associated conceptual relationships can be characterized, represented, and/or and described using one or more data structures, such as a graph having nodes (e.g., content modules and concepts) and edges (e.g., relationships), as a set of associated tags and attributes, or any combination thereof. In certain implementations, such content modules can be characterized based on the one or more feedback items (e.g., those received at 340). In one aspect, operation 350 is performed by one or more components depicted in FIGS. 1, 2, and/or 4.

By way of illustration, information pertaining to the clustering and about ordering of various content modules (such as is computed at 340) can be combined. Based on such data, an optimal grouping of items, videos, etc., can be generated (e.g., a grouping that groups together content modules that assess/teach the same concepts, and also, in certain implementations, separates items and videos that have different ordering requirements).

The referenced clusters can then be connected to one another and/or sequenced in relation to one another based on the ordering information/determination referenced herein. For example, those clusters that need to be seen before others can be associated with/connected to one another.

Based on such groupings, associations, sequences, etc., one or more course graphs can be generated. Such graphs can, for example, reflect the relationships, associations, sequences, etc., identified with respect to the various content modules, based upon which adaptive recommendations can be generated. It should be understood that, in certain implementations, all of the content modules within the provided body of content may be incorporated within a single connected graph covering one domain, while in other implementations, multiple disconnected graphs may result (e.g., if the graphed content modules cover multiple subject matter areas). In certain implementations, the referenced course graph(s) (and/or sections thereof, relationships contained therein, etc.) can be forwarded automatically to subject-matter experts, such as in order to review/confirm/modify certain aspects thereof, such as areas which may be questionable (e.g., in light of a lack of consensus in the feedback responses provided by various users).

Moreover, in certain implementations one or more of the referenced relationships, associations, sequences, etc., (e.g., between content modules and/or groups thereof) may be provided manually (e.g., from a subject matter expert, teacher, other users, etc.). In scenarios in which relationships, groupings, associations, etc., have been received from multiple subject matter experts, such collective feedback can be aggregated in order to determine useful groupings, orderings, etc., in light of the relationships, etc., identified by the various experts. Additionally, such relationships, groupings, etc., can be compared with those relationships, groupings, etc., that are generated in an automated fashion (such as is described herein), and such respective relationships, groupings, etc., can be combined, aggregated, and/or reconciled with one another. In doing so, one or more course graphs can be generated based on both automated and manual review of the content modules, which can be used for adaptive content recommendations, such as in a manner described herein.

It should be noted that the terms “instructor” and “student” are used generally as non- limiting examples as content may be used to instruct (i.e., for educational purposes) in variety of environments outside of an academic setting, such as in the workplace, for personal enrichment, etc. Thus, for example, a student 140A-C may represent any user who consumes content. In addition, an instructor may represent any individual or entity that collects and/or organizes content from one or more content sources for consumption by users.

In certain implementations, content recommendation system 150 includes content grouping engine 152. It should be understood that such an arrangement is exemplary and that in other implementations more or fewer content modules/applications may be employed in providing the various features, functionalities, and operations described herein.

It should also be understood that the various elements, components, and/or devices referenced herein can be combined together or separated into further components, according to a particular implementation. Additionally, in some implementations, various components (e.g., of content recommendation system 150) may run on separate machines.

In an example, content recommendation system 150 is accessed directly by one or more different computing systems, such as a computing system associated with a content provider 110A. In another example, content recommendation system 150 may be provided as one or more tools, add-ons, or application programming interfaces (APIs). As described in greater detail herein, while in certain implementations content grouping engine 152 may generate one or more course graphs describing educational content while in other implementations such course graphs may be generated (e.g., manually) and provided to the content grouping engine.

Moreover, in certain implementations the described technologies can employ various unique user interfaces. Such interfaces can include but are not limited to: item vs exemplars comparisons (e.g., inquiring as to which of these sets of exemplar is a particular item most like), item vs item comparisons (e.g., voting regarding what is the relationship), item vs taxonomy [list] comparisons (e.g., inquiring regarding tagging, e.g., what descriptors are pertinent to a particular question), etc. Moreover, in certain implementations item vs. exemplar can include a drop down menu and/or an interface control that enables auto-fill and/or pre-selection, e.g., of certain types/categories of exemplars. Moreover, in certain implementations the referenced interfaces can be listed, provided, and/or displayed in a sequence/order, e.g., in order of difficulty, such as depending on the determined sophistication, qualifications, etc. of the participant. (e.g., based on various inquiries, observations, etc.).

Additionally, it should be understood that, in certain implementations, the described and/or referenced data regarding crowd sourced impressions on pieces of content can be transformed into locations in a knowledge graph (as described herein). Moreover, after grouping users (e.g., in a manner described herein), a first (e.g., simpler) interface can be utilized initially (e.g., to get a baseline for the knowledge graph). Subsequently, more sophisticated interface(s) can be presented, e.g., to a user/device identified as being knowledgeable or subject matter expert. Moreover, in certain implementations users can progress through a sequence of interfaces (increasing in their respective sophistication, complexity, etc.) based on the described technologies identifying over time (and/or based on the received responses) whether such users are sophisticated. It can be appreciated that, over time, the described technologies can determined a user's expertise and can then route appropriate questions more efficiently.

It should also be noted that described technologies (including the described implementations of a knowledge graph) can, for example, enable comparing content against a pre-loaded knowledge graph, e.g., in a particular subject domain and such can further be used a as baseline/litmus test in order to more effectively benchmark the received responses (e.g., against similar like-minded content) and/or to quickly load such content into the right place in the knowledge graph. For example, in a scenario in which a knowledge graph is already in place, the described technologies can be employed in a scenario in which a user wishes to add content to that knowledge graph. Additionally, in certain implementations the described technologies can enable content on the graph to be routed more quickly/effectively to a specialist, e.g., having identified that a full crowd sourced review is not needed.

It should also be noted that, in certain implementations the collective wisdom of crowds can represent a perspective different from that of a smaller group of experts. For example, in certain scenarios, ordinary uninformed opinion may be likely to pick different results than those with ‘expert’ opinions. Accordingly, it would be impracticable to perform the described crowd-sourced comparisons to achieve such different results without the described technologies, systems, machines, etc.

It should also be noted that, in certain implementations inputs originating from the various sensors described/referenced herein (e.g., geographic/location coordinates, etc.) can be utilized to determine various aspects described herein and/or to enhance the various determinations described herein.

At this juncture it can be appreciated that, as has been described, various implementations of the disclosed technologies provide numerous advantages and improvements upon conventional approaches. It should also be noted that while the technologies described herein are illustrated primarily with respect to education content, such characterization is intended only by way of example and in the interests of clarity and brevity. However, it should be understood that the described technologies can also be implemented with respect to any other type of content (e.g., recreational content, gaming content, etc.), in any number of additional or alternative settings or contexts, and/or towards any number of additional objectives.

FIG. 4 depicts an illustrative computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server in client-server network environment. The machine may be a computing device integrated within and/or in communication with a vehicle, a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing system (processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 616, which communicate with each other via a bus 608.

Processor 602 represents one or more processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions 626 for performing the operations discussed herein.

The computer system 600 may further include a network interface device 622. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 616 may include a computer-readable medium 624 on which is stored one or more sets of instructions 626 which may embody any one or more of the methodologies or functions described herein. Instructions 626 may also reside, completely or at least partially, within the main memory 604 and/or within the processor 602 during execution thereof by the computer system 600, the main memory 604 and the processor 602 also constituting computer-readable media. Instructions 626 may further be transmitted or received over a network via the network interface device 622.

While the computer-readable storage medium 624 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “processing,” “providing,” “identifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. In certain implementations, this apparatus may be specially constructed for the required purposes. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It should be understood that the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to practically any type of data. The scope of the disclosure should, therefore, be determined with reference to the appended claims, along with the full scope of equivalents to which such claims are entitled.

What is claimed is:

1. A method comprising:
receiving a plurality of content items, each of the content items being associated with one or more respective metadata items;
processing, by a processing device, the plurality of content items and one or more corresponding metadata items to identify two or more potentially related content items;
providing the two or more potentially related content items to one or more users
receiving, from the one or more users, one or more feedback items with respect to the relationship between the two or more potentially related content items; and
categorizing at least one of the two or more potentially related content items based on the one or more feedback items.

2. A system, comprising:
a memory; and
a processing device, operatively coupled to the memory, to:
receive a plurality of content items, each of the content items being associated with one or more respective metadata items;
process the plurality of content items and one or more corresponding metadata items to identify two or more potentially related content items;
provide the two or more potentially related content items to one or more users;
receive, from the one or more users, one or more feedback items with respect to the relationship between the two or more potentially related content items; and
categorize at least one of the two or more potentially related content items based on the one or more feedback items.

3. A non-transitory computer readable medium having instructions stored thereon that, when executed by a processor, cause the processor to:
receive a plurality of content items, each of the content items being associated with one or more respective metadata items;
process, by the processing device, the plurality of content items and one or more corresponding metadata items to identify two or more potentially related content items;
provide the two or more potentially related content items to one or more users;
receive, from the one or more users, one or more feedback items with respect to the relationship between the two or more potentially related content items; and
categorize at least one of the two or more potentially related content items based on the one or more feedback items.
